(19) United States
(12) Patent Application Publication
(10) Pub. No.: US 2025/0233358 A1
(43) Pub. Date: Jul. 17, 2025

(54) Connector and Connector Assembly

(71) Applicants: SIBAS Electronics (Xiamen) Co. Ltd., Xiamen City (CN); Tyco Electronics (Shanghai) Co., Ltd., Shanghai (CN)

(72) Inventors: Lei Wang, Xiamen (CN); Liqiang (Gino) Yao, Shanghai (CN); Yong (Chris) Wang, Shanghai (CN); Qiang Yuan, Xiamen (CN); Dely (Roy) Liu, Xiamen (CN)

(73) Assignees: SIBAS Electronics (Xiamen) Co. Ltd., Xiamen City (CN); Tyco Electronics (Shanghai) Co., Ltd., Shanghai (CN)

(21) Appl. No.: 19/016,659

(22) Filed: Jan. 10, 2025

(30) Foreign Application Priority Data
Jan. 11, 2024 (CN) 202420072401.7

(51) Int. Cl. H01R 13/631; H01R 13/512; H01R 13/52

(52) U.S. Cl. CPC H01R 13/6315; H01R 13/512; H01R 13/5202

(57) ABSTRACT

A connector includes a housing with a height direction, a core installed in the housing, and a terminal disposed in the core and extending along the height direction. The core is floatably installed into the housing and can be moved relative to the housing in a direction perpendicular to the height direction.

### CROSS-REFERENCE TO RELATED APPLICATION

This application claims the benefit of the filing date under 35 U.S.C. § 119 (a)-(d) of Chinese Patent Application No. 202420072401.7, filed on Jan. 11, 2024.

### FIELD OF THE INVENTION

The present invention relates to a connector and a connector assembly comprising the connector.

### BACKGROUND OF THE INVENTION

A heavy-duty connector typically includes a housing, a core, and terminals. The core is fixed in the housing, and the terminals are installed in the core. The core generally cannot float relative to the housing. Therefore, when there is a misalignment between the heavy-duty connector and the mating heavy-duty connector, it is difficult for the two to match and, in severe cases, the two mated connectors may be damaged. In addition, there is often no waterproof structure between the heavy-duty connector and an installation panel, or between the heavy-duty connector and the mating heavy-duty connector, which makes it easy for water vapor to enter the interior of the heavy-duty connector, leading to damage and failure.

### SUMMARY OF THE INVENTION

A connector includes a housing with a height direction, a core installed in the housing, and a terminal disposed in the core and extending along the height direction. The core is floatably installed into the housing and can be moved relative to the housing in a direction perpendicular to the height direction.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows a transverse sectional view of a connector according to an exemplary embodiment of the present invention;

FIG. 3 shows a plan sectional view of a connector according to an exemplary embodiment of the present invention;

FIG. 4 shows a longitudinal sectional view of a connector according to an exemplary embodiment of the present invention;

FIG. 5 shows an sectional perspective view of the core and first end cap of a connector according to an exemplary embodiment of the present invention;

FIG. 6 shows an exploded perspective view of a connector assembly according to an exemplary embodiment of the present invention;

FIG. 7 shows a transverse sectional perspective view of the connector assembly shown in FIG. 6;

FIG. 8 shows a transverse sectional perspective view of a connector assembly according to an exemplary embodiment of the present invention;

FIG. 9 shows a longitudinal sectional view of a mating connector according to an exemplary embodiment of the present invention;

FIG. 10 shows another longitudinal sectional view of a mating connector according to an exemplary embodiment of the present invention; and

FIG. 11 shows an illustrative perspective view of the mating core and second end cap of a mating connector according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

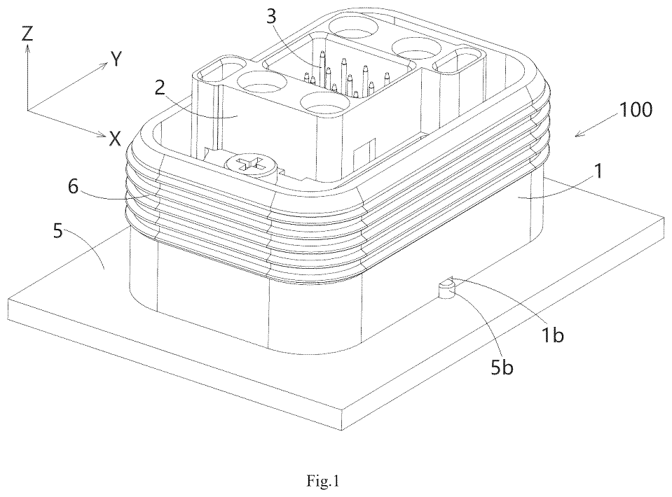

As shown in FIGS. 1 to 5, in another exemplary embodiment of the present invention, a connector 100 is disclosed. The connector 100 includes a housing 1, a core 2, and a terminal 3. The housing 1 has a transverse direction X, a longitudinal direction Y, and height direction Z. The core 2 is installed into the housing 1. The terminal 3 is provided in the core 2 and extends along the height direction Z of the housing 1. The core 2 is floatably installed into the housing 1 and can be moved relative to the housing 1 in a direction perpendicular to the height direction Z.

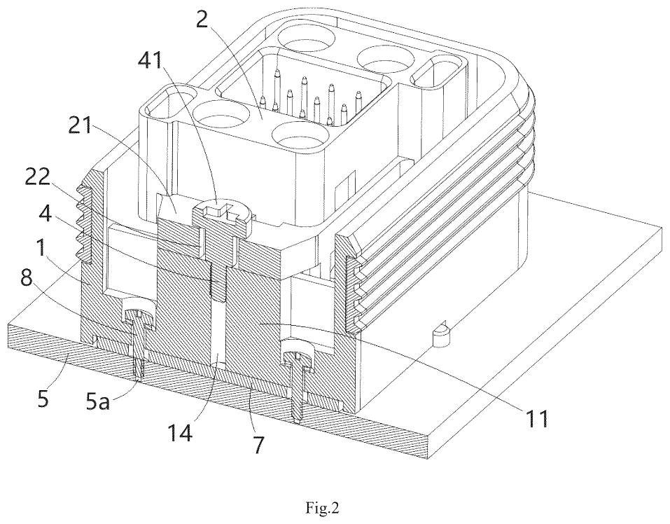

As shown in FIGS. 2, 3, and 5, in the illustrated embodiment, a first connection hole 22 is formed in the core 2, and a first threaded hole 14 is formed in the housing 1. The connector 100 also includes a first threaded connecting piece 4 that passes through the first connection hole 22 and is threaded into the first threaded hole 14. The diameter of the first threaded connecting piece 4 is smaller than that of the first connection hole 22, and the axial direction of the first connection hole 22 and the first threaded hole 14 is parallel to the height direction Z, so that the core 2 can be moved relative to the housing 1 in a radial direction of the first connection hole 22.

As shown in FIGS. 2 to 5, in the illustrated embodiment, the core 2 has a first connection car 21, the housing 1 has a first installation portion 11 protruding from the bottom wall of the housing 1, and the first connection hole 22 and the first threaded hole 14 are formed in the first connection ear 21 and the first installation portion 11, respectively. The distance between the head 41 of the first threaded connecting piece 4 and the first installation portion 11 in the height direction Z is greater than the thickness of the first connection car 21 in the height direction Z, allowing the core 2 to be moved relative to the housing 1 in the height direction Z.

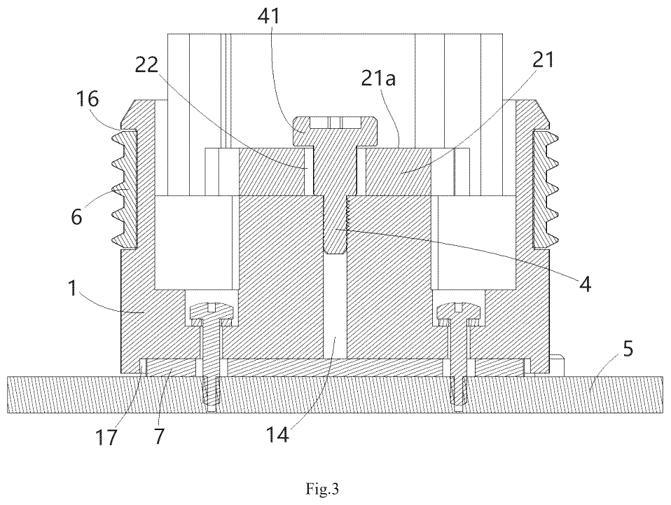

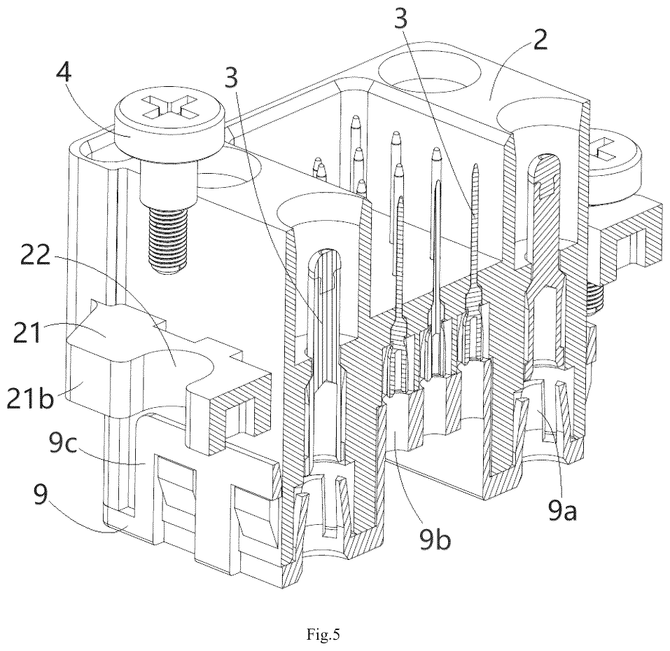

As shown in FIGS. 3 and 5, in the illustrated embodiment, the first connection car 21 has a first top surface 21a and a first bottom surface that are opposite in the height direction Z, as well as a first side surface 12b connected between the first top surface 21a and the first bottom surface and perpendicular to the longitudinal direction Y of the housing 1. The first connection hole 22 extends between the first top surface 21a and the first bottom surface and has a side opening formed on the first side surface 21b, such that the first connection hole 22 is a semi-circular slot with a side opening.

As shown in FIGS. 2, 4, and 5, in the illustrated embodiment, the core 2 has a pair of first connection cars 21 opposite each other in the longitudinal direction Y of the housing 1, and the housing 1 has a pair of first installation portions 11 corresponding to the pair of first connection cars 21. The connector 100 includes a pair of first threaded connecting pieces 4, which connect the pair of first connection cars 21 to the pair of first installation portions 11.

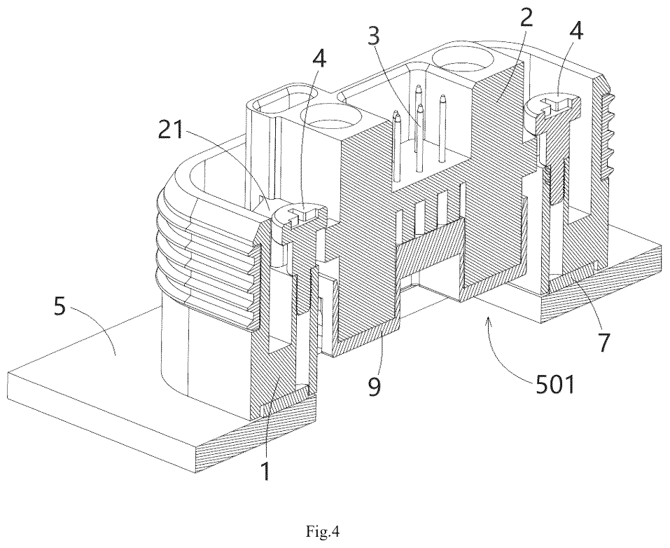

As shown in FIGS. 1 to 4, in the illustrated embodiment, the connector 100 further comprises a first installation panel 5 and a first sealing ring 7. The first installation panel 5 is formed with a first installation port 501. The first sealing ring 7 is set between the bottom wall of the housing 1 and the first installation panel 5. The bottom wall of housing 1 is fixed to the first installation panel 5 and formed with a bottom opening corresponding to the first installation port 501, shown in FIG. 4, to allow a first cable to pass through. A first sealing ring installation groove 17 is formed on the bottom wall of the housing 1 for installing and positioning the first scaling ring 7. The first sealing ring 7 surrounds the first installation port 501 and is compressed between the bottom wall of the housing 1 and the first installation panel 5 to achieve sealing between the two.

As shown in FIG. 2, in the illustrated embodiment, a first threaded connection hole 5a is formed in the first installation panel 5, and the connector 100 further includes a first screw 8. The first screw 8 passes through the bottom wall of the housing 1 and the through hole formed in the first sealing ring 7 and is threaded into the first threaded connection hole 5a to fix the housing 1 to the first installation panel 5.

As shown in FIG. 1, in the illustrated embodiment, a first anti-mis-operation hole 1b is formed in the bottom of one side of the housing 1, and a first anti-mis-operation protrusion 5b is formed on the first installation panel 5. The first anti-mis-operation protrusion 5b cooperates with the first anti-mis-operation hole 1b to prevent the housing 1 from being installed on the first installation panel 5 in the wrong orientation.

As shown in FIGS. 4 and 5, in the illustrated embodiment, the connector 100 further includes a first end cap 9, which is mounted on one end of the core 2 and has a first locking portion 9a that rests against the end face of the terminal 3 to prevent the terminal 3 from being pulled out of the core 2. A first elastic buckle 9c is formed on the first end cap 9, and the first elastic buckle 9c is fastened to one end of the core 2.

As shown in FIG. 5, in the illustrated embodiment, a first cable hole 9b is formed in the first end cap 9 to allow the first cable to pass through. The first cable is electrically connected to one end of the terminal 3 and led out from the core 2 through the first cable hole 9b. The other end of the terminal 3 is used to mate with a mating terminal 3′ of the mating connector 100′, described in greater detail below.

As shown in FIGS. 1, 3, 7, and 8, in the illustrated embodiment, the connector 100 further comprises an elastic sealing ring 6, which is fitted onto the outer wall of the housing 1. The elastic scaling ring 6 is adapted to be compressed between the housing 1 of the connector 100 and the mating housing 1′ of the mating connector 100′ to achieve sealing between the two.

As shown in FIG. 3, in the illustrated embodiment, a sealing ring installation groove 16 is formed on the peripheral wall of the housing 1, and the elastic sealing ring 6 is installed and positioned in the sealing ring installation groove 16.

As shown in FIGS. 1 to 11, in another exemplary embodiment of the present invention, a connector assembly is also disclosed. The connector component includes: a connector 100 and a mating connector 100′. The mating connector 100′ is mated with the connector 100.

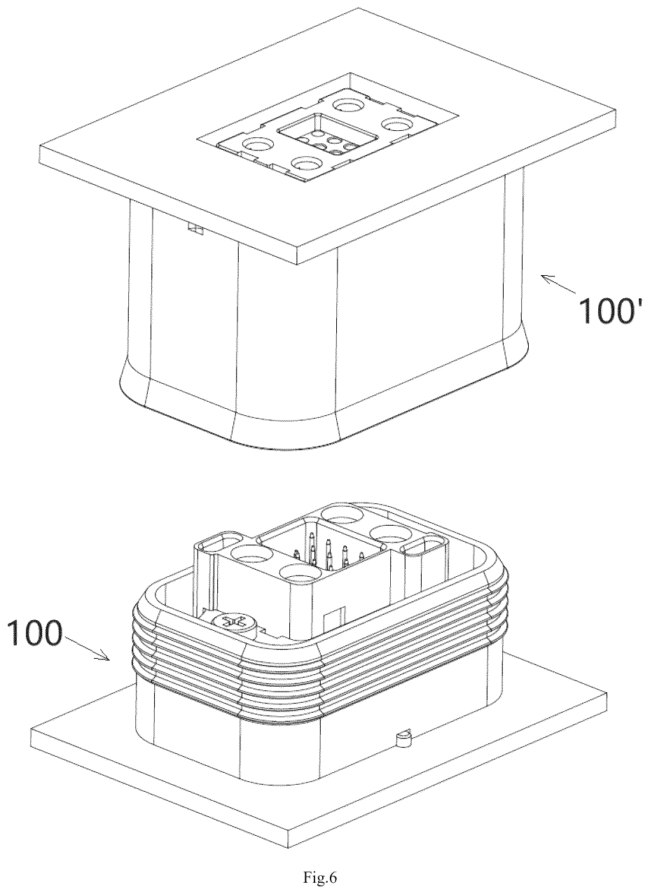

As shown in FIGS. 6 to 11, in the illustrated embodiment, the mating connector 100′ includes a mating housing 1′, a mating core 2′, and a mating terminal 3′. The mating housing 1′ is mated with the housing 1 of the connector 100. The mating core 2′ is installed into the mating housing 1′ and mated with the core 2 of the connector 100. The mating terminal 3′ is set in the mating core 2′ and mated with the terminal 3 of the connector 100. The mating core 2′ is floatably installed into the mating housing 1′ and can be moved relative to the mating housing 1′ in a direction perpendicular to the height direction Z of the mating housing 1′.

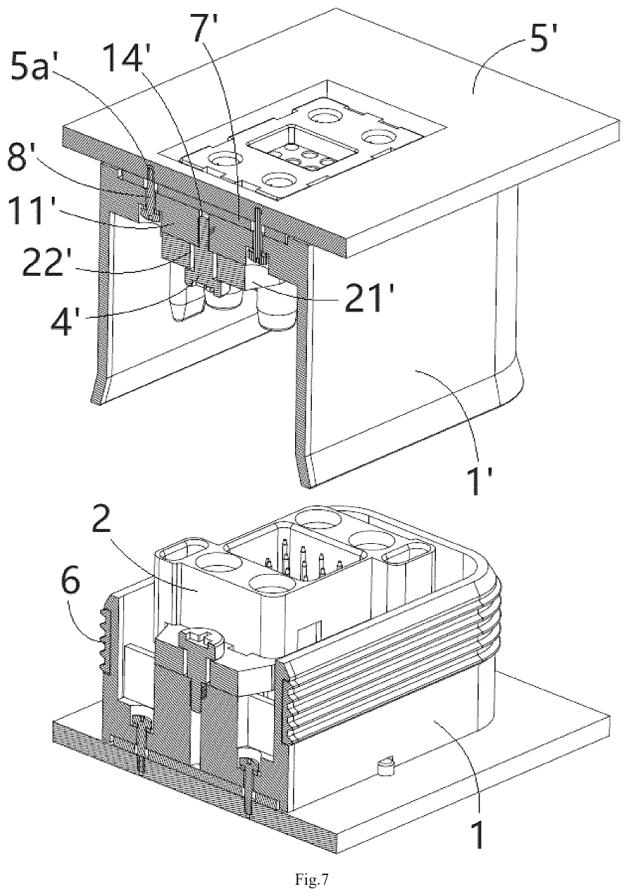

As shown in FIGS. 7, 9, and 11, in the illustrated embodiment, a second connection hole 22′ is formed in the mating core 2′, and a second threaded hole 14′ is formed in the mating housing 1′. The mating connector 100′ also includes a second threaded connecting piece 4′ that passes through the second connection hole 22′ and is threaded into the second threaded hole 14′. The diameter of the second threaded connecting piece 4′ is smaller than that of the second connection hole 22′, and the axial direction of the second connection hole 22′ and the second threaded hole 14′ is parallel to the height direction Z, so that the mating core 2′ can be moved relative to the mating housing 1′ in a radial direction of the second connection hole 22′.

As shown in FIGS. 7 to 11, in the illustrated embodiment, the mating core 2′ has a second connection ear 21′, and the mating housing 1′ has a second installation portion 11′ located on the bottom wall of the mating housing 1′. The second connection hole 22′ and the second threaded hole 14′ are formed in the second connection ear 21′ and the second installation portion 11′, respectively. The distance between the head 41′ of the second threaded connecting piece 4′ and the second installation portion 11′ in the height direction Z is greater than the thickness of the second connection ear 21′ in the height direction Z, allowing the mating core 2′ to move relative to the mating housing 1′ in the height direction Z.

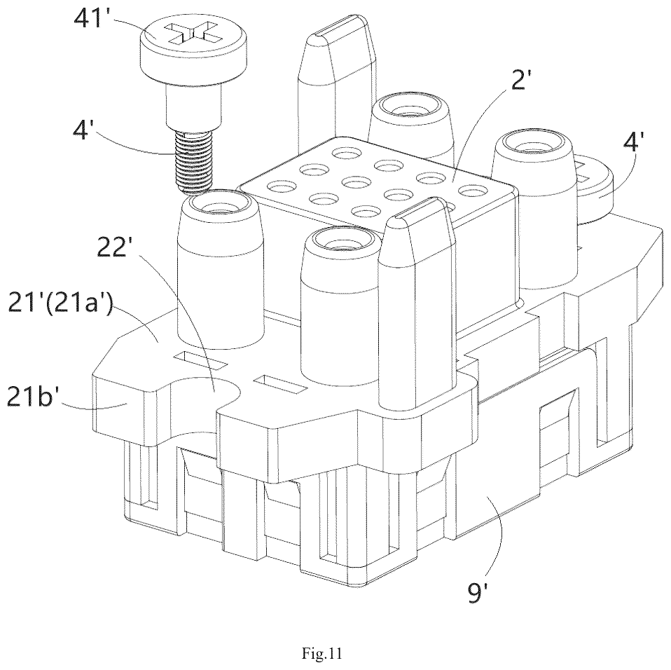

As shown in FIG. 11, in the illustrated embodiment, the second connection ear 21′ has a second top surface 21a′ and a second bottom surface that are opposite in the height direction Z, as well as a second side surface 21b′ connected between the second top surface 21a′ and the second bottom surface and perpendicular to the longitudinal direction Y of the mating housing 1′. The second connection hole 22′ extends between the second top surface 21a′ and the second bottom surface and has a side opening formed on the second side surface 21b′, such that the second connection hole 22′ is a semi-circular slot with a side opening.

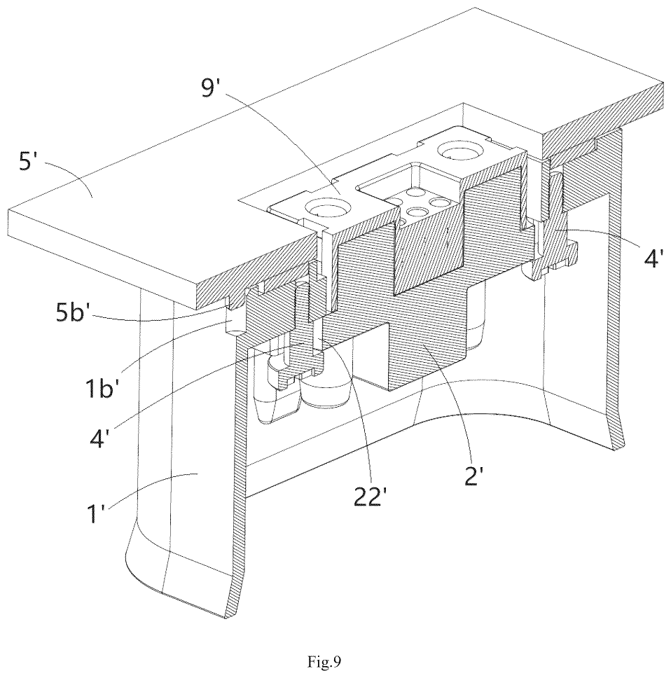

As shown in FIGS. 9 to 11, in the illustrated embodiment, the mating core 2′ has a pair of second connection ears 21′ opposite to each other in the longitudinal direction Y of the mating housing 1′, and the mating housing 1′ has a pair of second installation portions 11′ corresponding to the pair of second connection ears 21′. The mating connector 100′ includes a pair of second threaded connecting pieces 4′, which connect the pair of second connection ears 21′ to the pair of second installation portions 11′.

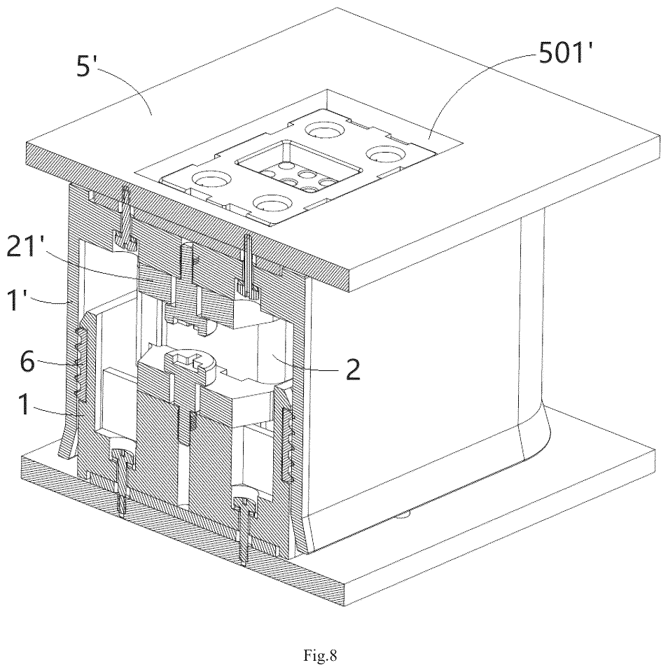

As shown in FIGS. 7 and 8, in the illustrated embodiment, the connector assembly further comprises a second installation panel 5′ and a second sealing ring 7′. The second installation panel 5′ is formed with a second installation port 501′. The second sealing ring 7′ is set between the bottom wall of the mating housing 1′ and the second installation panel 5′. The bottom wall of the mating housing 1′ is fixed to the second installation panel 5′ and formed with a bottom opening corresponding to the second installation port 501′ to allow a second cable to pass through. A second sealing ring installation groove 17′ is formed on the bottom wall of the mating housing 1′ for installing and positioning the second sealing ring 7′. The second sealing ring 7′ surrounds the second installation port 501′ and is compressed between the bottom wall of the mating housing 1′ and the second installation panel 5′ to achieve sealing between the two.

As shown in FIG. 7, in the illustrated embodiment, a second threaded connection hole 5a′ is formed in the second installation panel 5′, and the mating connector 100′ further includes a second screw 8′. The second screw 8′ passes through the bottom wall of the mating housing 1′ and the through hole formed in the second sealing ring 7′ and is threaded into the second threaded connection hole 5a′ to fix the mating housing 1′ to the second installation panel 5′.

As shown in FIG. 9, in the illustrated embodiment, a second anti-mis-operation hole 1b′ is formed in the bottom of one side of the mating housing 1′, and a second anti-mis-operation protrusion 5b′ is formed on the second installation panel 5′. The second anti-mis-operation protrusion 5b′ cooperates with the second anti-mis-operation hole 1b′ to prevent the mating housing 1′ from being installed on the second installation panel 5′ in the wrong orientation.

As shown in FIGS. 9 to 11, in the illustrated embodiment, the mating connector 100′ further includes a second end cap 9′, which is mounted on one end of the mating core 2′ and has a second locking portion 9a′ that rests against the end face of the mating terminal 3′ to prevent the mating terminal 3′ from being pulled out of the mating core 2′. A second elastic buckle 9c′ is formed on the second end cap 9′, and the second elastic buckle 9c′ is fastened to one end of the mating core 2′.

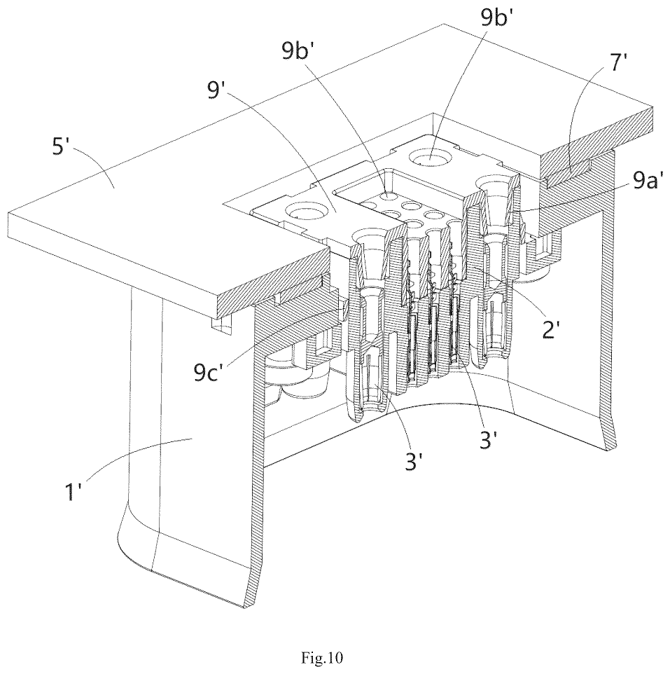

As shown in FIG. 10, in the illustrated embodiment, a second cable hole 9b′ is formed in the second end cap 9′ to allow the second cable to pass through. The second cable is electrically connected to one end of the mating terminal 3′ and is led out from the mating core 2′ through the second cable hole 9b′. The other end of the mating terminal 3′ is used for mating with the terminal 3 of the connector 100.

In the aforementioned exemplary embodiments according to the present invention, the core 2 is floatably installed in the housing 1, so even if there is misalignment between the connector 100 and the mating connector 100′, smooth mating of the connector 100 and the mating connector 100′ is ensured without causing damage to the connector 100 and the mating connector 100′.

In the aforementioned exemplary embodiments according to the present invention, an clastic sealing ring 6 is provided between the housing 1 of the connector 100 and the mating housing 1′ of the mating connector 100′, thereby effectively preventing water vapor from entering the connector 100 and the mating connector 100′.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector, comprising:
a housing with a height direction;
a core installed in the housing; and
a terminal disposed in the core and extending along the height direction, the core is floatably installed into the housing and can be moved relative to the housing in a direction perpendicular to the height direction.

2. The connector according to claim 1, wherein the core has a first connection hole, the housing has a first threaded hole, the connector further comprises a first threaded connecting piece that passes through the first connection hole and is threaded into the first threaded hole, a diameter of the first threaded connecting piece is smaller than the first connection hole, and an axial direction of the first connection hole and the first threaded hole is parallel to the height direction, the core can be moved relative to the housing in a radial direction of the first connection hole.

3. The connector according to claim 2, wherein the core has a first connection ear, the housing has a first installation portion protruding from a bottom wall of the housing, the first connection hole and the first threaded hole are respectively formed in the first connection ear and the first installation portion, a distance between a head of the first threaded connecting piece and the first installation portion in the height direction is greater than a thickness of the first connection ear in the height direction, the core can be moved relative to the housing in the height direction.

4. The connector according to claim 3, wherein the first connection ear has a first top surface and a first bottom surface that are opposite in the height direction, and a first side surface connected between the first top surface and the first bottom surface and perpendicular to a longitudinal direction of the housing, the first connection hole extends between the first top surface and the first bottom surface and has a side opening formed in the first side surface, the first connection hole is a semi-circular slot hole with a side opening.

5. The connector according to claim 4, wherein the first connection ear is one of a pair of first connection ears opposite each other in the longitudinal direction of the housing, the first installation portion is one of a pair of first installation portions respectively corresponding to the pair of first connection ears, the first threaded connecting piece is one of a pair of first threaded connecting pieces that respectively connect the pair of first connection ears to the pair of first installation portions.

6. The connector according to claim 1, further comprising a first installation panel having a first installation port, and a first sealing ring provided between a bottom wall of the housing and the first installation panel, the bottom wall of the housing is fixed to the first installation panel and has a bottom opening corresponding to the first installation port and receiving a first cable, a first sealing ring installation groove is formed on the bottom wall of the housing and positions a first sealing ring, the first sealing ring surrounds the first installation port and is compressed between the bottom wall of the housing and the first installation panel to seal between the housing and the first installation panel.

7. The connector according to claim 6, wherein a first threaded connection hole is formed in the first installation panel, the connector further comprises a first screw that passes through the bottom wall of the housing and a through hole formed in the first sealing ring, the first screw is threaded into the first threaded connection hole to fix the housing to the first installation panel.

8. The connector according to claim 6, wherein a bottom of a side of the housing has a first anti-mis-operation hole, and a first anti-mis-operation protrusion is formed on the first installation panel, the first anti-mis-operation protrusion cooperates with the first anti-mis-operation hole to prevent the housing from being installed on the first installation panel in a wrong orientation.

9. The connector according to claim 6, further comprising a first end cap installed on an end of the core, the first end cap has a first locking portion that rests against an end face of an end of the terminal to prevent the terminal from being pulled out of the core, a first elastic buckle is formed on the first end cap and is fastened to the end of the core, a first cable hole is formed in the first end cap and receives a first cable, the first cable is electrically connected to the end of the terminal and is led out from the core through the first cable hole, another end of the terminal mates with a mating terminal of a mating connector.

10. The connector according to claim 1, further comprising an elastic sealing ring fitted onto a peripheral wall of the housing, the elastic sealing ring is compressed between the housing and a mating housing of a mating connector to seal between the housing and the mating housing.

11. A connector assembly, comprising:
a connector including a housing with a height direction, a core installed in the housing, and a terminal disposed in the core and extending along the height direction, the core is floatably installed into the housing and can be moved relative to the housing in a direction perpendicular to the height direction; and
a mating connector mated with the connector.

12. The connector assembly according to claim 11, wherein the mating connector includes:
a mating housing mated with the housing of the connector;
a mating core installed in the mating housing and mated with the core of the connector; and
a mating terminal disposed in the mating core and mated with the terminal of the connector, the mating core is floatably installed in the mating housing and can be moved relative to the mating housing in a direction perpendicular to the height direction.

13. The connector assembly according to claim 12, wherein the mating core has a second connection hole, the mating housing has a second threaded hole, the mating connector includes a second threaded connecting piece that passes through the second connection hole and is threaded into the second threaded hole, a diameter of the second threaded connecting piece is smaller than that of the second connection hole, and an axial direction of the second connection hole and the second threaded hole is parallel to the height direction, the mating core can be moved relative to the mating housing in a radial direction of the second connection hole.

14. The connector assembly according to claim 13, wherein the mating core has a second connection car, the mating housing has a second installation portion located on a bottom wall of the mating housing, the second connection hole and the second threaded hole are formed respectively in the second connection car and the second installation portion, a distance between a head of the second threaded connecting piece and the second installation portion in the height direction is greater than a thickness of the second connection car in the height direction, the mating core can be moved relative to the mating housing in the height direction.

15. The connector assembly according to claim 14, wherein the second connection car has a second top surface and a second bottom surface opposite each other in the height direction, and a second side surface connected between the second top surface and the second bottom surface and perpendicular to a longitudinal direction of the mating housing, the second connection hole extends between the second top surface and the second bottom surface and has a side opening formed in the second side surface, the second connection hole is a semi-circular slot with a side opening.

16. The connector assembly according to claim 15, wherein the second connection car is one of a pair of second connection ears opposite to each other in the longitudinal direction of the mating housing, the second installation portion is one of a pair of second installation portions respectively corresponding to the pair of second connection ears, the mating connector comprises a pair of second threaded connecting pieces, which respectively connect the pair of second connection ears to the pair of second installation portions.

17. The connector assembly according to claim 12, further comprising a second installation panel having a second installation port and a second sealing ring provided between a bottom wall of the mating housing and the second installation panel, the bottom wall of the mating housing is fixed to the second installation panel and has a bottom opening corresponding to the second installation port to receive a second cable, a second sealing ring installation groove is formed on the bottom wall of the mating housing and positions the second sealing ring, the second sealing ring surrounds the second installation port and is compressed between the bottom wall of the mating housing and the second installation panel to seal between the mating housing and the second installation panel.

18. The connector assembly according to claim 17, wherein a second threaded connection hole is formed in the second installation panel, the mating connector further comprises a second screw that passes through the bottom wall of the mating housing and a through hole formed in the second sealing ring and is threaded into the second threaded connection hole to fix the mating housing to the second installation panel.

19. The connector assembly according to claim 17, wherein a second anti-mis-operation hole is formed in a bottom of a side of the mating housing, and a second anti-mis-operation protrusion is formed on the second installation panel, the second anti-mis-operation protrusion cooperates with the second anti-mis-operation hole to prevent the mating housing from being installed on the second installation panel in a wrong orientation.

20. The connector assembly according to claim 17, wherein the mating connector further comprises a second end cap installed on an end of the mating core and has a second locking portion that rests against an end face of an end of the mating terminal to prevent the mating terminal from being pulled out of the mating core, a second elastic buckle is formed on the second end cap and fastens to the end of the mating core, the second cable hole is formed in the second end cap to receive the second cable, the second cable is electrically connected to the end of the mating terminal and is led out from the mating core through the second cable hole, another end of the mating terminal mates with the terminal of the connector.
